(19) United States
(12) Patent Application Publication
(10) Pub. No.: US 2024/0385311 A1
(43) Pub. Date: Nov. 21, 2024

(54) VEHICULAR SENSING SYSTEM WITH CAMERA HAVING INTEGRATED RADAR

(71) Applicant: Magna Electronics Inc., Auburn Hills, MI (US)

(72) Inventor: Wilhelm Johann Wolfgang Wöhlte, Sailauf (DE)

(21) Appl. No.: 18/665,784

(22) Filed: May 16, 2024

Related U.S. Application Data
(60) Provisional application No. 63/503,211, filed on May 19, 2023.

(51) Int. Cl. G01S 13/86; G01S 13/931; G06V 10/80; H04N 23/51; H04N 25/76

(52) U.S. Cl. CPC G01S 13/867; G01S 13/931; G06V 10/803; H04N 25/76; G01S 2013/9318; G01S 2013/93185; H04N 23/51

(57) ABSTRACT

A vehicular sensing system includes a camera disposed at a vehicle and capturing image data. The system includes a radar sensor sensing exterior of the equipped vehicle, the radar sensor capturing radar data. The system includes a display disposed within the vehicle and viewable by a driver of the vehicle. The vehicular sensing system, responsive to processing by a data processor of image data captured by the camera and of radar data captured by the radar sensor, fuses the image data and the radar data. The vehicular sensing system detects an object within the field of view of the camera and the field of sensing of the radar sensor and determines height of the detected object relative to the ground. The display displays information pertaining to the determined height of the detected object relative to the ground.

### CROSS REFERENCE TO RELATED APPLICATION

The present application claims the filing benefits of U.S. provisional application Ser. No. 63/503,211, filed May 19, 2023, which is hereby incorporated herein by reference in its entirety.

### FIELD OF THE INVENTION

The present invention relates generally to a vehicle sensing system for a vehicle and, more particularly, to a vehicle sensing system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular sensing system includes a camera disposed at a vehicle equipped with the vehicular sensing system. The camera views exterior of the equipped vehicle. The camera is operable to capture image data. The camera includes an imager and a lens, and the imager includes a CMOS imaging array having at least one million photosensors arranged in rows and columns. The system includes a radar sensor disposed at the equipped vehicle that senses exterior of the equipped vehicle. The radar sensor is operable to capture radar data. The system includes an electronic control unit (ECU) with electronic circuitry and associated software. Image data captured by the camera is transferred to the ECU, and radar data captured by the radar sensor is transferred to the ECU. The electronic circuitry of the ECU includes at least one data processor that is operable to (i) process image data captured by the camera and transferred to the ECU and (ii) process radar data captured by the radar sensor and transferred to the ECU. A field of view of the camera at least partially overlaps a field of sensing of the radar sensor. A display disposed within the vehicle and viewable by a driver of the vehicle. The vehicular sensing system, responsive to processing at the ECU of image data captured by the camera and radar data captured by the radar sensor, fuses the image data and the radar data into fused data. Via processing at the ECU of the fused data, the vehicular sensing system detects an object within the field of view of the camera and the field of sensing of the radar sensor and determines height of the detected object relative to the ground. The display displays information pertaining to the determined height of the detected object relative to the ground.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras and a radar sensor;

FIG. 2 depicts schematic views of cameras without integrated radar;

FIG. 3 is a schematic view of a camera with integrated radar;

FIG. 4 is a plan view of a vehicle with an electronic control unit and head unit;

FIG. 5 is an image of a bird's eye view of a vehicle with a potential obstacle; and

FIG. 6 is a plan view of a vehicle next to a potential obstacle.

### DESCRIPTION OF THE PREFERRED EMBODIMENTS

A vehicle sensing system and/or driver or driving assist system and/or object detection system and/or alert system operates to capture data representative of an exterior of the vehicle and may process the captured data to display images and to detect objects at or near the vehicle and in the predicted path of the vehicle, such as to assist a driver of the vehicle in maneuvering the vehicle in a rearward direction. The sensing system includes a data processor or processing system that is operable to receive sensor data from one or more sensors and provide an output to a display device for displaying images representative of the captured sensor data. Optionally, the sensing system may provide a display, such as a rearview display or a top down or bird's eye or surround view display or the like.

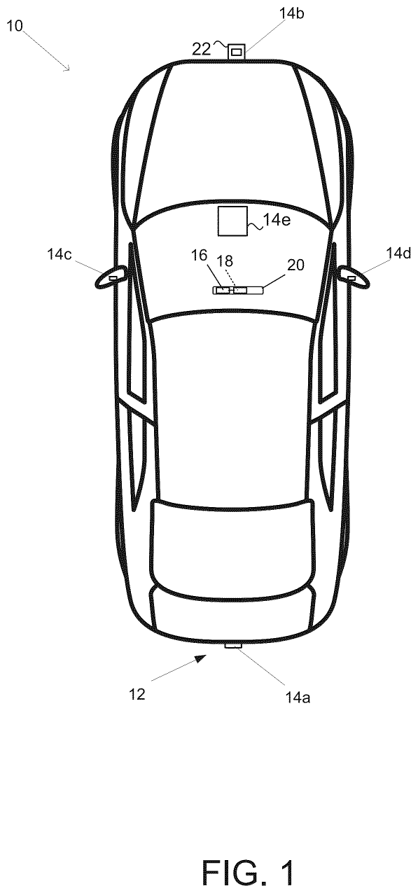

Referring now to the drawings and the illustrative embodiments depicted therein, a vehicle 10 includes an sensing system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera 14e may be disposed at the windshield of the vehicle and view through the windshield and forward of the vehicle, such as for a machine vision system (such as for traffic sign recognition, headlamp control, pedestrian detection, collision avoidance, lane marker detection and/or the like). One or more of the cameras includes an integrated radar sensor 22 that captures radar data. The sensing system 12 includes a control or electronic control unit (ECU) 18 having electronic circuitry and associated software, with the electronic circuitry including a data processor or image processor that is operable to process data captured by the camera or cameras and radar sensors, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

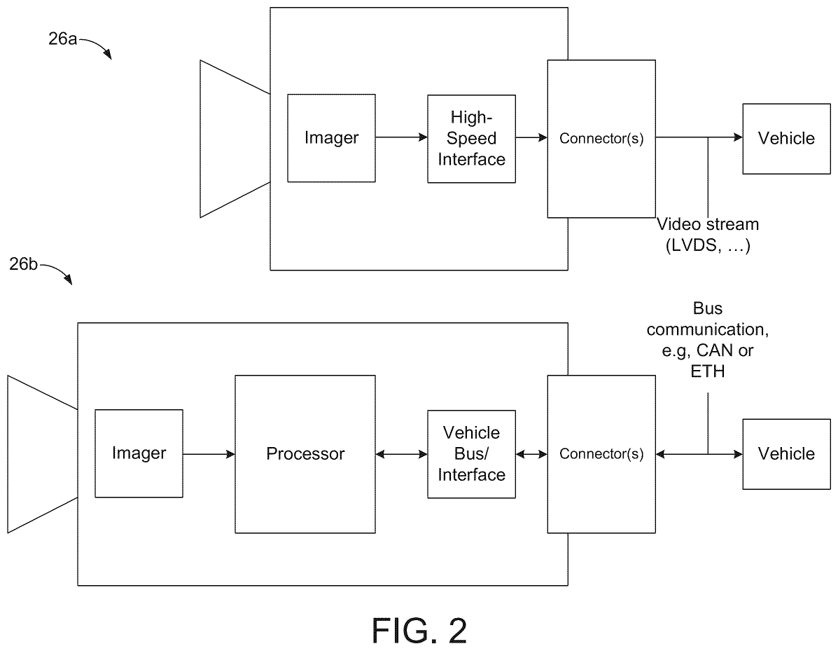

Referring now to FIG. 2, automotive cameras today generally are one of two types: a camera 26a that includes an integrated processor to process image data captured by the camera or a camera 26b that does not include an integrated processor (and instead, for example, relies on a remote ECU of the vehicle to process captured image data). Currently, these cameras are not able to provide reliable height information of objects in their field of view (i.e., the cameras provide only 2D data). In some cases, the object may appear to have a certain height (i.e., a distance between the ground and the object) from the video data, but the object is actually flat or nearly flat and can be safely driven over. For example, current techniques using these cameras may find it difficult to differentiate a curb (that is not safe to drive over) from a marking on the street/parking area (that is safe to drive over).

Radar sensors often provide a better resolution and robustness compared to ultrasonic sensors. For example, some radar sensors may detect five or more attributes when needed (e.g., range/distance, velocity, azimuth, elevation, and material) regardless of light level (i.e., during night or day) and are not as sensitive to weather conditions as ultrasonic sensors or lidar sensors.

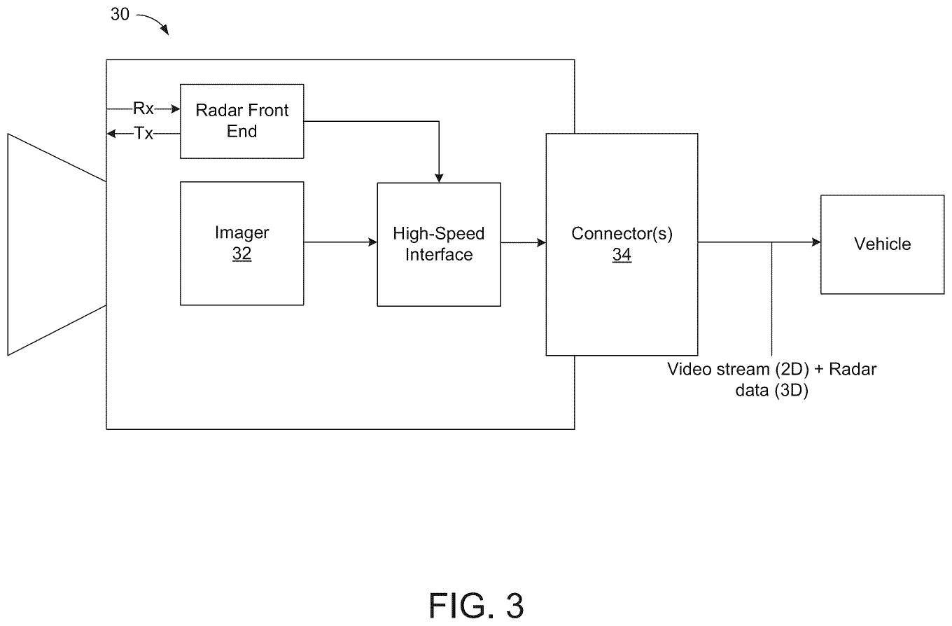

Implementations herein include a vision system or sensing system that utilizes a vehicular camera module 30 (FIG. 3) that integrates a camera and radar functionality into the same housing/module. The camera module combines automotive camera features such as providing an image directly to a display and/or to another ECU to combine the image with other video streams (surround view), while also simultaneously providing radar data such as, but not limited to, height information of objects within the field of view of the camera. Accordingly, the field of view of the camera at least partially overlaps the field of sensing of the radar sensor. Optionally, a principal viewing axis of the camera is generally parallel with a principal sensing axis of the radar sensor. Thus, the system combines the sensor data of two sensors in a single package or housing to provide additional protection to the vehicle, such as protection for the tires, the rims, and/or the bumpers of the vehicle and to provide protection to people and objects with a combination of two-dimensional (2D) data (from the image sensor) and three-dimensional (3D) data (i.e., 3D object data from the radar sensor). Additionally, the vehicle does not require an additional sensor (i.e., a separate radar sensor), which reduces costs, saves time, and reduces the required space in the vehicle. The system provides a combination of 2D data (camera video stream) and 3D data (radar data) directly.

Image data captured by an image sensor (imager) 32 of the camera module 30 may be streamed (e.g., via one or more connectors 34) to another device (e.g. a display). An antenna may be embedded into the mechanical parts of the camera module 30, such as the housing and/or the lens of the camera module 30. The antenna transmits and receives radar signals to detect obstacles or other objects in the field of view of the camera. The radar data captured by the radar sensor may be embedded in the video data and transmitted simultaneously with the image/video data. Additionally or alternatively, the radar data may be transmitted over a separate interface (e.g., via a controller area network (CAN)).

The camera with integrated radar may be assembled in a single box/package. That is, the radar sensor and the imager may be co-located within a housing of the camera. For example, the package includes (i) a lens for catching the light/information, (ii) an antenna structures for RX signals and TX signals, (iii) one or more printed circuits boards, (iv) one or more supporting circuits such as power supplies, (v) an image sensor and radar front end, (vi) an optional vehicle interface such as CAN-FD or Ethernet for providing point cloud or similar information to the rest of the vehicle, and/or (vii) a high-speed data interface for streaming the video data and/or embedded radar data to the rest of the vehicle. In some examples, components of the radar and camera may be co-located on the same printed circuit board to further save cost and/or space. The radar sensor and the imager may share a processor or ECU. That is, the same processor located within the housing of the camera may process both the image data captured by the camera and radar data captured by the radar. The image data and the radar data may be output using the same connector/interface simultaneously or separately. Additionally or alternatively, the image data and the radar data may be output using an independent connector/interface.

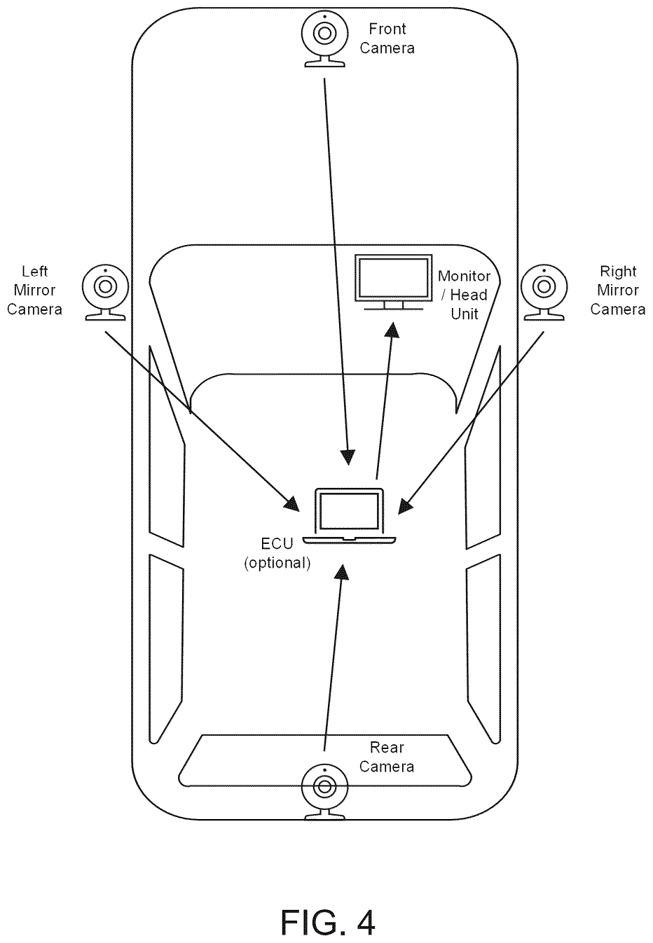

Referring now to FIG. 4, the system may include cameras installed at multiple positions in the vehicle (e.g., at the side exterior rearview mirrors, at a front bumper of the vehicle, at a rear bumper of the vehicle (and optionally with the imager of the sensing module comprising the imager of the rear backup camera of the vehicle), at a trunk of the vehicle, at a windshield of the vehicle, etc.) and operates without any driver interaction. Fusion of sensor data may be performed at one or more of the cameras, at a surround view ECU, at a domain controller, at a head unit, etc. In the example of FIG. 4, at least four cameras provide video data or image data to an ECU. The ECU combines the streams of images/video to generate different views (e.g., a birds-eye view, a surround view, etc.). The ECU is optional as fusion may instead be performed directly at the head unit.

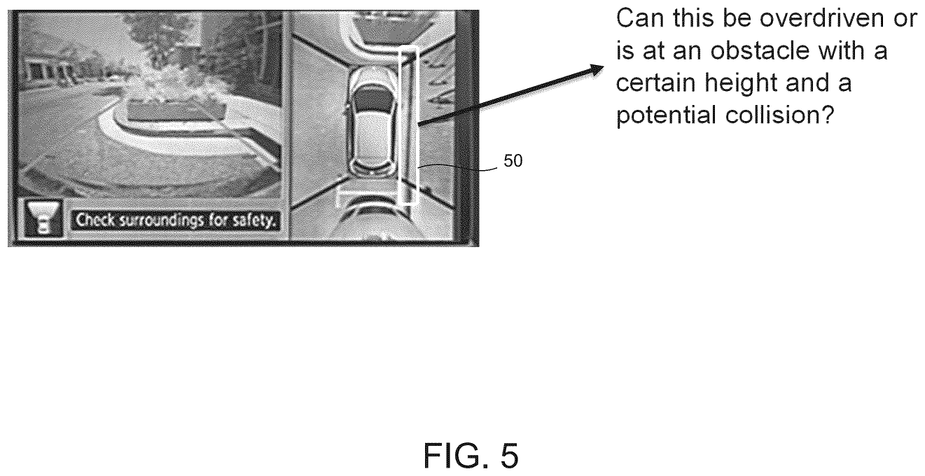

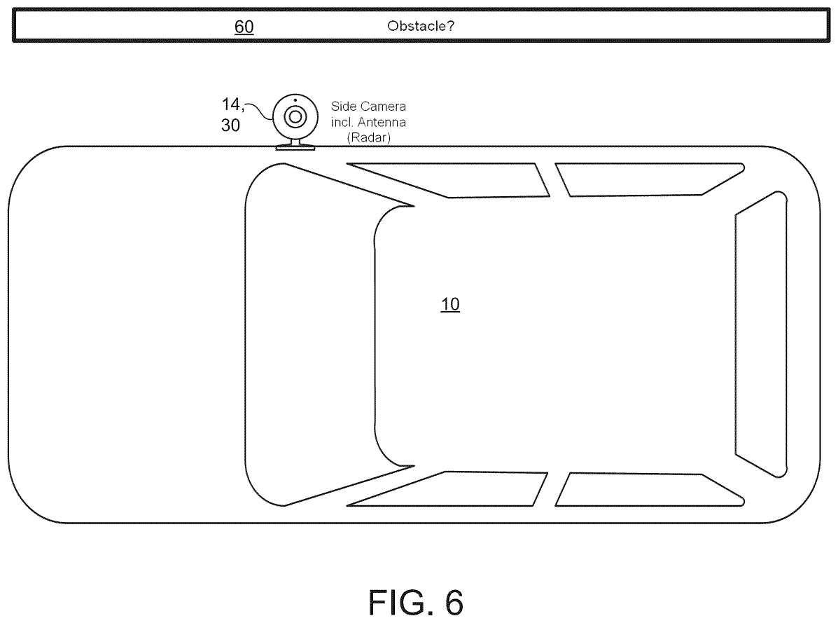

FIG. 5 illustrates a common example of a deficiency that conventional systems encounter. Here, the bounding box 50 bounds a dark line in a bird's eye view. It is unclear from the image data whether this is, for example, a shadow on the ground that can be safely driven over or an object (e.g., a curb) with sufficient height that it poses a risk to the vehicle. Continuing this example, FIG. 6 includes a vehicle 10 equipped with the side camera 30 sitting next to a potential obstacle 60. From image data alone, it is unclear if the potential obstacle 60 is a curb, a marking, a shadow, etc. That is, this image is insufficient for determining a height of the object relative to the ground. The sensing system in this example includes the camera 30 (FIG. 3) with integrated radar. Thus, the single camera generates data that ensures synchronization between 2D data (captured via the camera) and 3D data (captured via the integrated radar). The 2D video data and the 3D radar data (that includes the height of the potential obstacle 60) can be fused and provided to the driver to clarify whether the potential obstacle 60 is a threat. For example, the fused data may indicate the height of one or more objects in the image data. The system may warn or notify the driver or other occupants of the vehicle, provide information to the occupants of the vehicle, and/or perform an automated braking or steering maneuver to avoid a collision with the detected object. The system may indicate the height of the objects in any number of ways, such as via graphic overlays that include text, color gradients, or bounding boxes. For example, the system overlays image data (captured by the camera) depicting one or more objects displayed on a display within the vehicle with information that indicates a height of the object(s) and/or indicates whether the height of any of the objects constitutes a threat to the vehicle. In some examples, the system indicates that the height of an object does not constitute a threat to the vehicle. Additionally or alternatively, the system may alert or warn the driver of the vehicle to threats with an audible and/or haptic warning.

Thus, implementations herein include a vehicular sensing system or vehicular vision system that includes a camera or other image sensor with integrated radar. The radar includes antenna elements that are, for example, integrated into a housing, a lens, or a holder of the camera. The antenna elements may be small due to automotive approved frequency range and/or detection range. The camera may be located at any number of locations around the vehicle, such as at the front, corner, sides, or rear of the vehicle. The camera with integrated radar generates and outputs 2D data and 3D data (i.e., data with height information). The data may be embedded together (i.e., fused or otherwise shared over the same interface) and/or transmitted using separate outputs/connectors.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system utilizes sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a camera disposed at a vehicle equipped with the vehicular sensing system, the camera viewing exterior of the equipped vehicle;
wherein the camera is operable to capture image data;
wherein the camera comprises an imager and a lens, and wherein the imager comprises a CMOS imaging array having at least one million photosensors arranged in rows and columns;
a radar sensor disposed at the equipped vehicle, the radar sensor sensing exterior of the equipped vehicle;
wherein the radar sensor is operable to capture radar data;
an electronic control unit (ECU) comprising electronic circuitry and associated software;
wherein image data captured by the camera is transferred to the ECU, and wherein radar data captured by the radar sensor is transferred to the ECU;
wherein the electronic circuitry of the ECU comprises at least one data processor that is operable to (i) process image data captured by the camera and transferred to the ECU and (ii) process radar data captured by the radar sensor and transferred to the ECU;
wherein a field of view of the camera at least partially overlaps a field of sensing of the radar sensor;
a display disposed within the vehicle and viewable by a driver of the vehicle;
wherein the vehicular sensing system, responsive to processing at the ECU of image data captured by the camera and radar data captured by the radar sensor, fuses the image data and the radar data into fused data;
wherein, via processing at the ECU of the fused data, the vehicular sensing system detects an object within the field of view of the camera and the field of sensing of the radar sensor and determines height of the detected object relative to the ground; and
wherein the display displays information pertaining to the determined height of the detected object relative to the ground.

2. The vehicular sensing system of claim 1, wherein a camera module accommodates the camera and the radar sensor.

3. The vehicular sensing system of claim 2, wherein the camera module outputs the image data via a first connector, and wherein the camera outputs the radar data via a second connector.

4. The vehicular sensing system of claim 3, wherein the first connector and the second connector are different.

5. The vehicular sensing system of claim 2, wherein the camera module outputs, via a connector, the image data embedded with the radar data.

6. The vehicular sensing system of claim 2, wherein the radar sensor comprises an antenna, and wherein the antenna is embedded within a housing of the camera module.

7. The vehicular sensing system of claim 1, wherein the fused data comprises a surround view of the equipped vehicle.

8. The vehicular sensing system of claim 1, wherein the fused data comprises a bird's-eye-view of the equipped vehicle.

9. The vehicular sensing system of claim 1, wherein the camera is disposed at one selected from the group consisting of (i) a front of the vehicle, (ii) a rear of the vehicle, (iii) a side of the vehicle and (iv) an exterior rearview mirror assembly at a side of the vehicle.

10. The vehicular sensing system of claim 1, wherein the vehicular sensing system fuses the image data and the radar data at a head unit disposed within the equipped vehicle.

11. The vehicular sensing system of claim 1, wherein the vehicular sensing system determines, using the determined height, a collision threat with the equipped vehicle, and wherein the vehicular sensing system, responsive to determining the collision threat, controls at least one selected from the group consisting of (i) steering of the equipped vehicle and (ii) braking of the equipped vehicle.

12. The vehicular sensing system of claim 1, wherein the vehicular sensing system determines, using the determined height, a collision threat with the equipped vehicle, and wherein the vehicular sensing system, responsive to determining the collision threat, generates a warning for the driver of the equipped vehicle.

13. The vehicular sensing system of claim 1, wherein the camera and the radar sensor are accommodated by a camera module having a housing, and wherein the imager and the radar sensor are co-located within the housing.

14. The vehicular sensing system of claim 1, wherein the imager has a principal viewing axis and the radar sensor has a principal sensing axis, and wherein the principal viewing axis and the principal sensing axis are parallel.

15. The vehicular sensing system of claim 1, wherein the fused data comprises three-dimensional object information.

16. The vehicular sensing system of claim 1, wherein the display displays video images derived from image data captured by the camera, and wherein the displayed video images include the detected object, and wherein the displayed information pertaining to the determined height of the detected object relative to the ground comprises an indication of the determined height of the detected object displayed at the display with the video images.

17. A vehicular sensing system, the vehicular sensing system comprising:
a camera module disposed at a vehicle equipped with the vehicular sensing system;
wherein the camera module comprises a camera, the camera viewing exterior of the equipped vehicle;
wherein the camera is operable to capture image data;
wherein the camera comprises an imager and a lens, and wherein the imager comprises a CMOS imaging array having at least one million photosensors arranged in rows and columns;
wherein the camera module comprises a radar sensor, the radar sensor sensing exterior of the equipped vehicle;
wherein the radar sensor is operable to capture radar data;
an electronic control unit (ECU) comprising electronic circuitry and associated software;
wherein image data captured by the camera is transferred to the ECU, and wherein radar data captured by the radar sensor is transferred to the ECU;
wherein the electronic circuitry of the ECU comprises at least one data processor that is operable to (i) process image data captured by the camera and transferred to the ECU and (ii) process radar data captured by the radar sensor and transferred to the ECU;
wherein a field of view of the camera at least partially overlaps a field of sensing of the radar sensor;
a display disposed within the vehicle and viewable by a driver of the vehicle;
wherein the vehicular sensing system, responsive to processing at the ECU of image data captured by the camera and radar data captured by the radar sensor, fuses the image data and the radar data into fused data;
wherein, via processing at the ECU of the fused data, the vehicular sensing system detects an object within the field of view of the camera and the field of sensing of the radar sensor and determines height of the detected object relative to the ground;
wherein the display displays information pertaining to the determined height of the detected object relative to the ground; and
wherein the vehicular sensing system determines, using the determined height, a collision threat with the equipped vehicle, and wherein the vehicular sensing system, responsive to determining the collision threat, controls at least one selected from the group consisting of (i) steering of the equipped vehicle and (ii) braking of the equipped vehicle.

18. The vehicular sensing system of claim 17, wherein the camera module outputs the image data via a first connector, and wherein the camera outputs the radar data via a second connector.

19. The vehicular sensing system of claim 18, wherein the first connector and the second connector are different.

20. The vehicular sensing system of claim 17, wherein the camera module outputs, via a connector, the image data embedded with the radar data.

21. The vehicular sensing system of claim 17, wherein the radar sensor comprises an antenna, and wherein the antenna is embedded within a housing of the camera module.

22. A vehicular sensing system, the vehicular sensing system comprising:
a camera disposed at a vehicle equipped with the vehicular sensing system, the camera viewing exterior of the equipped vehicle;
wherein the camera is operable to capture image data;
wherein the camera comprises an imager and a lens, and wherein the imager comprises a CMOS imaging array having at least one million photosensors arranged in rows and columns;
a radar sensor disposed at the equipped vehicle, the radar sensor sensing exterior of the equipped vehicle;
wherein the radar sensor is operable to capture radar data;
an electronic control unit (ECU) comprising electronic circuitry and associated software;
wherein image data captured by the camera is transferred to the ECU, and wherein radar data captured by the radar sensor is transferred to the ECU;
wherein the electronic circuitry of the ECU comprises at least one data processor that is operable to (i) process image data captured by the camera and transferred to the ECU and (ii) process radar data captured by the radar sensor and transferred to the ECU;
wherein a field of view of the camera at least partially overlaps a field of sensing of the radar sensor;
a display disposed within the vehicle and viewable by a driver of the vehicle;
wherein the vehicular sensing system, responsive to processing at the ECU of image data captured by the camera and radar data captured by the radar sensor, fuses the image data and the radar data into fused data, and wherein the vehicular sensing system fuses the image data and the radar data at a head unit disposed within the equipped vehicle;
wherein, via processing at the ECU of the fused data, the vehicular sensing system detects an object within the field of view of the camera and the field of sensing of the radar sensor and determines height of the detected object relative to the ground; and
wherein the vehicular sensing system determines, using the determined height, a collision threat with the equipped vehicle, and wherein the vehicular sensing system, responsive to determining the collision threat, generates a warning for the driver of the equipped vehicle, and wherein the warning comprises the display displaying information pertaining to the determined height of the detected object relative to the ground.

23. The vehicular sensing system of claim 22, wherein the camera and the radar sensor are accommodated by a camera module having a housing, and wherein the imager and the radar sensor are co-located within the housing.

24. The vehicular sensing system of claim 22, wherein the imager has a principal viewing axis and the radar sensor has a principal sensing axis, and wherein the principal viewing axis and the principal sensing axis are parallel.

25. The vehicular sensing system of claim 22, wherein the fused data comprises three-dimensional object information.
